(19) United States
(12) Patent Application Publication
(10) Pub. No.: US 2024/0032154 A1
(43) Pub. Date: Jan. 25, 2024

(54) ENERGY EFFICIENT TWIN REVERSED SPIRAL CONFIGURED HEATING ELEMENT AND GAS HEATER USING THE SAME

(71) Applicants: Ramgopal Vissa, Hyderbad (IN); Sajji Sriramu, Hyderbad (IN); Venkata Burada, Cincinnati, OH (US); Jainagesh Sekhar, Cincinnati, OH (US)

(72) Inventors: Ramgopal Vissa, Hyderbad (IN); Sajji Sriramu, Hyderbad (IN); Venkata Burada, Cincinnati, OH (US); Jainagesh Sekhar, Cincinnati, OH (US)

(73) Assignee: MHI Health Devices, LLC., Cincinnati, OH (US)

(21) Appl. No.: 17/916,078

(22) PCT Filed: Jan. 11, 2022
(86) PCT No.: PCT/US2022/011889

§ 371 Date: Sep. 30, 2022

Related U.S. Application Data
(60) Provisional application No. 63/167,203, filed on Mar. 29, 2021.
(60) Provisional application No. 63/235,938, filed on Aug. 23, 2021.

(51) Int. Cl. H05B 3/42; H05B 3/03

(52) U.S. Cl. CPC H05B 3/42; H05B 3/03; H05B 2203/012; H05B 2203/022

(57) ABSTRACT

Presented is an electrically charged heating element configured as a twin reversed spiral or other flat shape for high power density during cross current fluid flow. In one embodiment the element material is wound clockwise in a spiral inwardly to a point and then wound counterclockwise in a spiral outwardly from that point on the same plane as the clockwise winding, and between the clockwise windings, to a point past the beginning of the outer clockwise winding. Hot fluid generators employing such elements singly or in multiple stacked configurations are presented as well.

### CROSS-REFERENCE TO RELATED APPLICATIONS

This application claims the benefit of U.S. provisional applications 63/167,203 and 63/235,938 both entitled “Twin Reversed Spiral Configured Heating Element and Gas Heater Using the Same” filed on Mar. 29, 2021 and Aug. 23, 2021, respectively, the disclosures of which are incorporated by reference herein in their entirety.

### BACKGROUND

This application concerns electrically powered heating element design and application for use in hot gas, liquid, fluid or plasma generators. Such generators are common and may heat a gas electrically, by passing the gas through, and past, one or more electrically charged heating elements and any refractory packed around the heating elements. The refractory may be porous or grooved, allowing for increased gas flow and heat transfer to the gas, including the generation of a hot thermal plasma or a fluid with activated species. Often these heating elements are straight, elongated or u-shaped and are positioned parallel to the fluid flow in the generator resulting in the accumulation of heat by the fluid flow as it passes the charged elements.

### SUMMARY

In general, this application specifically presents a novel and innovative hot gas generator comprised in part of a flat configured heating element comprised of element stock manipulated or bent in a grid (square) or coil (round) pattern. The element material may be of flat or round stock and may be bent in a manner so that a flat face is created having the above mentioned grid or coil pattern. This flat face is then positioned perpendicular to a fluid flow whereby the flow may contact the complete flat face of the element.

Such an element configuration may create a condition whereby no stagnant flow points (regions of circulatory large eddies or laminar boundary layers) accumulate inside a hot gas generator so equipped. In comparison, stagnant points may develop easily in heaters provided with long straight or long u-shaped elements. When stagnation occurs, efficiency is reduced and hot spots are created. Flat, including flat spiral, elements tend to eliminate these conditions.

A specific preferred embodiment is comprised of twin reversed spiral heating elements (SH elements). The SH elements may be comprised of flat stock having a width and a depth. Other material configurations such as, but not limited to, round stock are also contemplated. The heating element stock is wound in a spiral configuration inward then reversed and wound outward forming concentric rings in opposing directions. These elements may be used singly or in multiple stacked configurations within hot gas generators wherein a fluid is projected by and through the charged elements and associated refractory material picking up heat and generating a highly heated gas or plasma. Such generators include those patented by the applicants encompassing U.S. Pat. Nos. 5,963,709, 6,816,671, 8,119,954, 8,435,549, 10,088,149 and 10,677,493 which are incorporated by reference in their entireties. Such spiral elements may be effectively used as an alternative to current straight or helical heating elements since they offer very low pressure drops, high compactness, good turn-down ratios and very stable high temperature operations.

Turn-down is an industry term describing the condition where an electrical device can be used at 100% power or lower percentages of available power. A spiral (SH) element may be turned-down more than is typical since the cross-section remains the same, but varying length sections may be employed.

### DRAWINGS—FIGURES

FIG. 1 displays an electrically charged heating element having a twin reversed spiral configuration wherein the element material is wound counter-clockwise inward in a spiral towards the center of the spiral to a point where it is wound clockwise outwardly in a spiral between the clockwise windings to a point outside of the counter-clockwise windings.

FIG. 2 displays an electrically charged heating element having a twin reversed spiral configuration where in the element material is wound clockwise inward in a spiral towards the center of the spiral to a point where it is wound counter-clockwise outwardly in a spiral between the clockwise windings to a point outside of the clockwise windings.

FIG. 3 is an isometric view of element as depicted in FIG. 2.

FIG. 4 is an isometric view of a stack or array of multiple heating elements as depicted in FIG. 3 encased in refractory material and equipped with external busbars for attachment to a power source.

FIG. 5 is an isometric view of a stack or array of multiple heating elements as depicted in FIG. 3 equipped with external busbars for attachment to a power source.

FIG. 6 is an isometric view of a stack or array of nine heating elements as depicted in FIG. 3.

FIG. 7 is an isometric view of a stack or array of two heating elements as depicted in FIG. 3.

FIG. 8 is a view of the twin reversed spiral pattern of a stack of two heating elements as depicted in FIG. 3. The two elements are rotationally offset showing an overlap of the elements.

FIG. 9 is an isometric view of a stack or array of three heating elements as depicted in FIG. 3.

FIG. 10 is an isometric view of a high temperature gas heater containing an array of multiple flat heating elements as described and depicted in FIGS. 1-9.

FIG. 11 is a side view of the high temperature gas heater of FIG. 10.

FIG. 12 is a view of the intake end of the high temperature gas heater of FIG. 10.

FIG. 13 is a view of the exhaust end of the high temperature gas heater of FIG. 10.

FIG. 14 is a partial cut-away view of the exhaust end of a high temperature gas heater showing an insulating means for the exhaust line and attached flanges.

FIG. 15 is an example of a flat heating element showing the pattern created by the manipulation or bending of the heating element stock material. This patterned face would be oriented perpendicular to a fluid flow. This example shows rows of rectangles arranged generally in a circle.

FIG. 16 is an example of a flat heating element showing the pattern created by the manipulation or bending of the heating element stock material. This patterned face would be oriented perpendicular to a fluid flow. This example shows rows of bent and twisted flat stock arranged generally in a circle.

FIG. 17 is an isometric view of the element presented in FIG. 16.

FIG. 18 is an example of a flat heating element showing the pattern created by the manipulation or bending of the heating element stock material. This patterned face would be oriented perpendicular to a fluid flow. This example shows a grid round stock arranged in a square pattern.

FIG. 19 is an isometric view of the element presented in FIG. 18.

FIG. 20 is an isometric view of an array of elements showing the direction of a fluid flow in relation to the array in black arrows.

DRAWING - REFERENCE NUMERALS

| | | | |
|---|---|---|---|
| 10. | twin spiral heating element | 12. | element stock |
| 15. | initial spiral | 20. | return spiral |
| 25. | spiral interspace | 30. | spiral reversal |
| 32. | spiral overlap | 35. | central void |
| 40. | terminal | 100. | element array |
| 110. | refractory | 115. | busbar |
| 120. | shorting link | 200. | gas heater |
| 205. | housing | 220. | intake end |
| 225. | port | 230. | exhaust end |
| 232. | exhaust line | 234. | outer liner |
| 236. | inner liner | 238. | exhaust line refractory |
| 240. | air gap | 242. | flange |
| 250. | flat round element | 260. | flat twist element |
| 270. | flat square element | | |

### DESCRIPTION

This application presents a heating element that allows for the highest density of power for a cross current flow to the element. As stated above, the application anticipates an electrically charged heating element comprised of flat, round or other shaped element material stock that is formed into a grid, coil or spiral pattern in a flat orientation. The flat orientation refers to an element configuration of a grid, coil or spiral that predominately forms a plane in a single direction. The plane will be comprised of the grid, coil or spiral pattern formed by the manipulation of the element stock. The flat face would then be positioned perpendicular to the direction of a fluid flow allowing the charged element to heat the flow. Such elements differ from elongated or u-shaped elements that are positioned parallel to a fluid flow.

As stated above, a preferred embodiment of the disclosed heating element is comprised of a length of material that is wound in a spiral in either a clockwise or counter-clockwise or both directions mostly inwardly. The winding is begun after a length of element material is established as a terminal that extends outwardly from the surface of the spiral. The initial winding of the material continues inward to a point near the center of the spiral where it reverses direction and then is wound in a spiral outwardly in the same plane as the initial spiral and between the initial spirals until it is outside of the initial spiral where it is terminated by the formation of a second terminal extending from the surface of the spiral. The terminals are attached to an electrical power source (not pictured).

The spiral may be comprised of any suitable heating element material. The element may be comprised of flat stock having a length, width and depth with the flat stock being wound in a spiral parallel to the length dimension, across the width dimension and perpendicular to the depth dimension. Round stock and other geometries are contemplated as well. It has been found that twin spirals provide opposing magnetic fields in the element spiral which gives auto stability.

### DETAILED DESCRIPTION

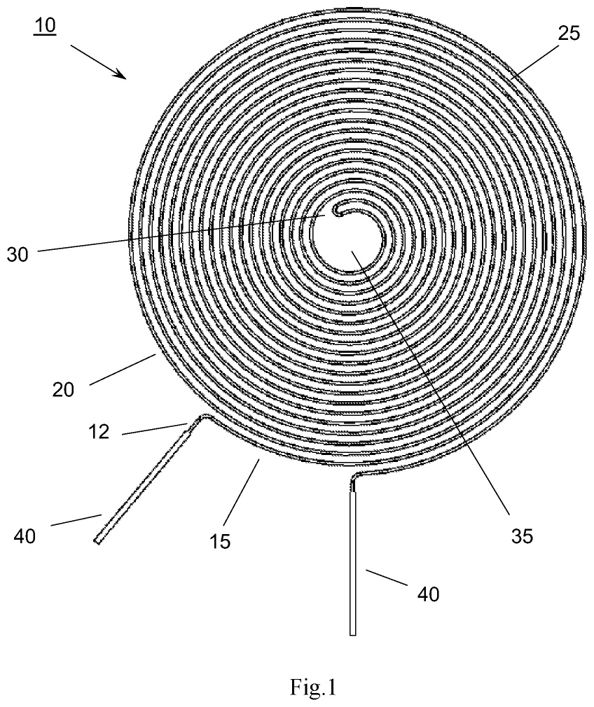

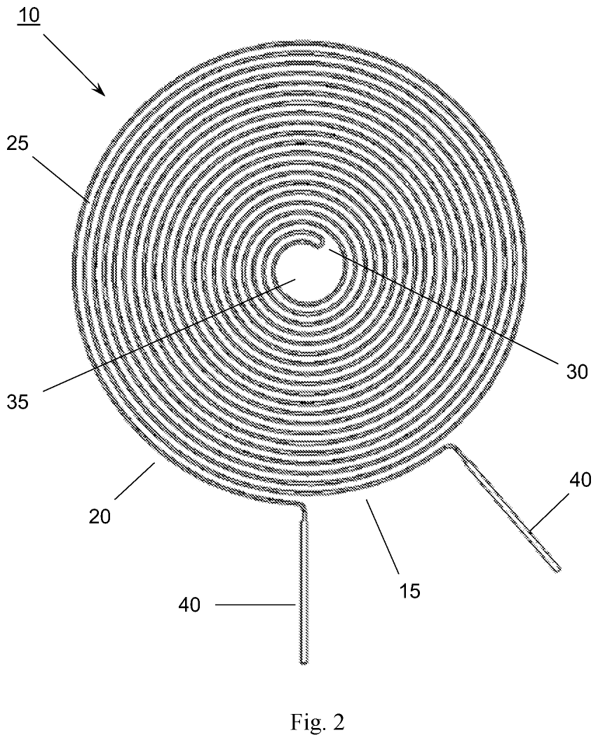

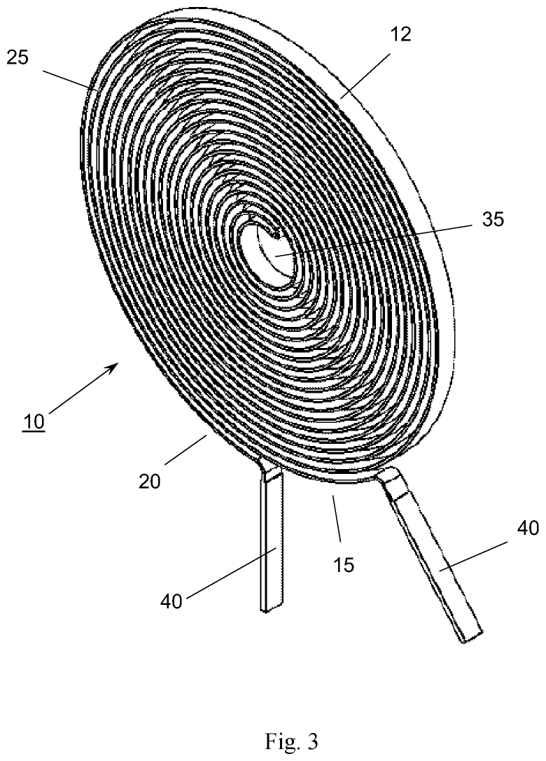

FIG. 1 shows a preferred embodiment of the disclosed twin spiral heating element 10 comprising a first terminal 40 perpendicular to the outer surface of the spiral. Where the first terminal 40 meets the spiral heating element stock 12, which in this embodiment is flat stock, the flat stock is wound in a spiral configuration inwardly in a counter-clockwise direction in line with the length of the flat stock in an initial spiral 15. The winding in the counter-clockwise direction continues to a point near the center of the spiraled element forming a central void 35. At this point the flat stock reverses itself, possibly in a u-turn, or spiral reversal 30 or other configuration, and is wound in a spiral configuration outwardly in a clockwise direction in a secondary or return spiral 20, between, opposed to and in the same plane as the windings of the initial spiral 15. The clockwise winding continues outwardly until the outside of the initial spiral 15 is reached. The initial spirals 15 and secondary spirals 20 are in a single plane. The return spiral 20 ends in a second terminal 40 projecting in a perpendicular direction out from the surface of the spiral heating element stock 12. The terminals 40 may project out from the stock 12 at any position relative to each other and may project at angles other than the perpendicular where they connect to a power supply (not pictured). FIGS. 2 and 3 show the opposite face of heating element 10 where the initial spiral 15 proceeds inwardly in a clockwise direction and the return spiral 20 travels outwardly in a counter-clockwise attitude.

A spiral interface 25 is defined between the initial spiral 15 and the return spiral 20. There may be shock resistant ceramic spacers positioned between the spirals 15 an 20 in the interface 25. The positioning of the spacers allow for separation and thermal mass build between the two spiral segments. This is particularly important for large currents that may cause distortion of the element from electromagnetic forces. A ceramic spacer with or without other appendages may also be positioned in the central void 35 of the element 10. The spacers may be kept loose or rigid (rigid spacers are generally not found in coil configurations but may be with twin reverse spiral configuration). The spiral pitch of the spirals 15 and 20 may vary between 4.5 mm and 5.5 mm. The distance between the spirals 15 and 20 may also vary, but a suggested embodiment has a distance of 12 mm. High power loading or watt-density ranging from 25 W/cm² to 30 W/cm² with high energy efficiency is anticipated. In one anticipated embodiment, the open area a between the spirals is over 80% but still allows for high KW and high temperature generation.

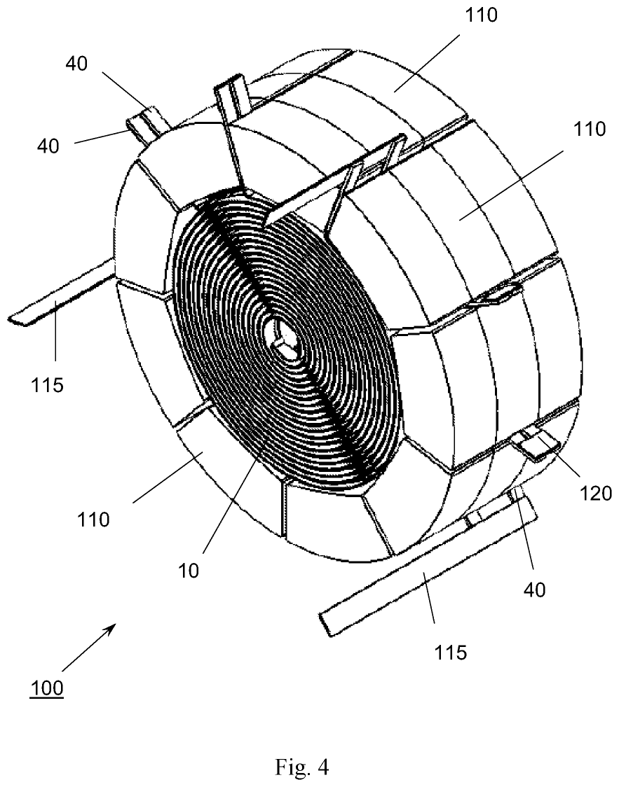

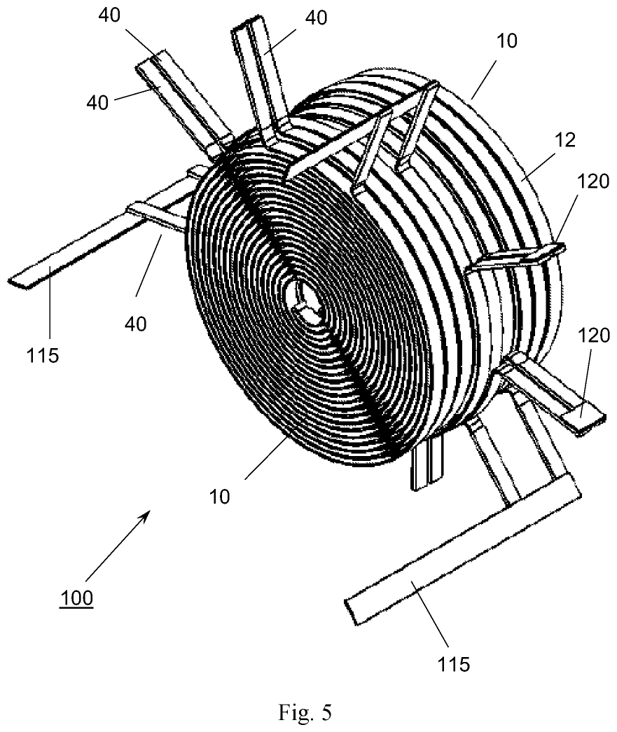

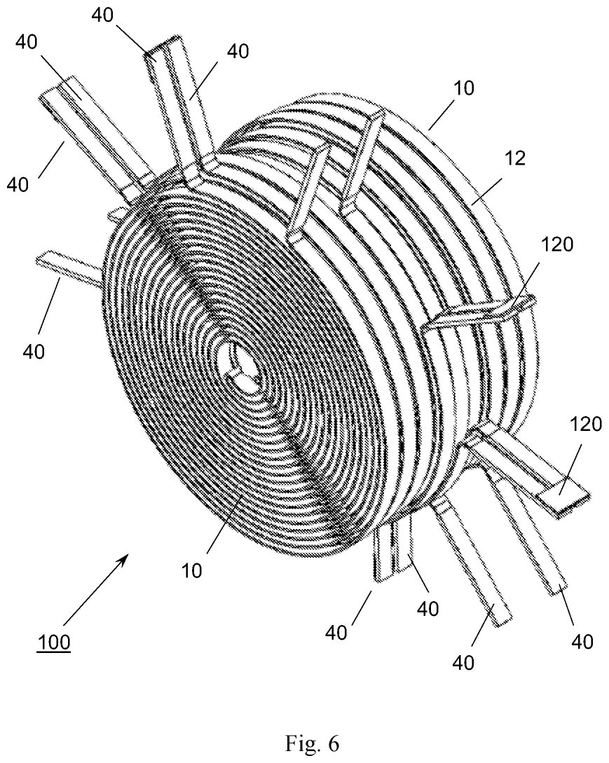

The disclosed spiraled elements 10 may be used individually or in multiples (FIGS. 4-9) in an array 100 with series or parallel connections. FIG. 4 shows an array 100 of 9 spiral elements 10 encased in refractory 110. Protruding through the refractory 110 are terminals 40 some of which are connected to each other by busbars 115 or shorting links 120. The shorting links 120 connect two elements 10 in series while the busbars 115 supply power to the elements 10 from a power source.

In an array 100 the multiple twin reversed spiral elements 10 are stacked side by side and may be stacked or arranged side by side at an offset and inverse to one another (clockwise start next to a counter-clockwise start). It has been found that such an arrangement creates a reticulate honeycomb structure which acts to break up any laminar flow and creates a high turbulent flow resulting in a higher heat transfer coefficient. In a contemplated embodiment the individual heating element spirals 10 are positioned at a 30° to 60° offset in plane and also out of plane. Other offsets at different angles are contemplated as well as different combinations of clockwise spiral start and counter-clockwise spiral start in the element array 100.

TABLE 1
Flat stock dimensions of an anticipated embodiment
as well as expected voltage, current and power.

| | | |
|---|---|---|
| Width | 15 | mm |
| Thickness | 2 | mm |
| Length | 9.7 | m |
| Voltage | 76 | V |
| Current | 156 | A |
| Power | 11.87 | kW |
| SL | 3.6 | W/Cm² |

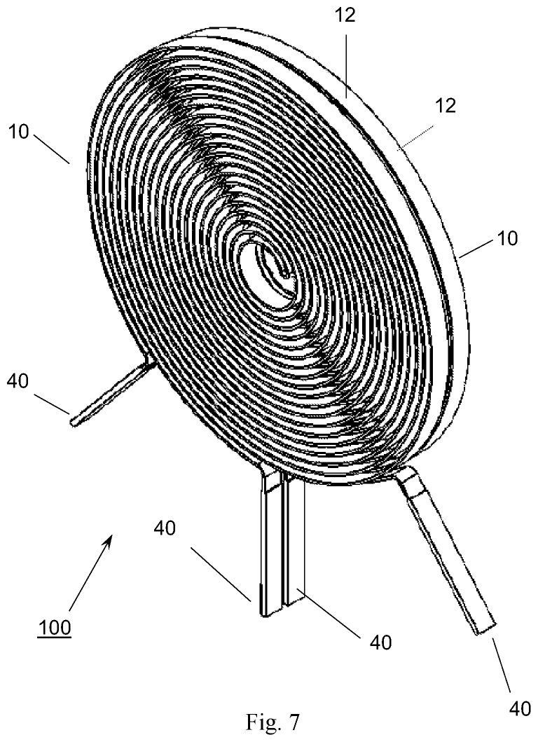

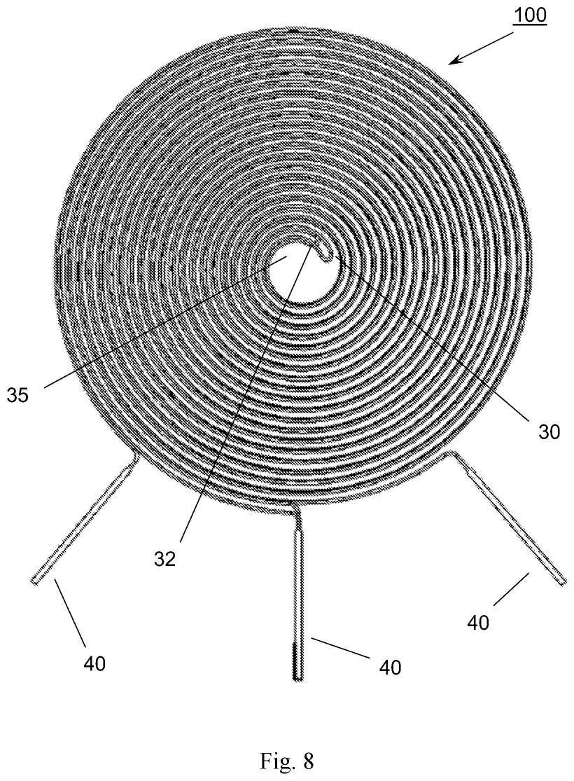

FIGS. 7 and 8 show an array 100 comprised of a pair of spiral elements 10. The elements 10 are positioned side at an offset producing an spiral overlap 32 of the elements 10 in the central void 35. The elements 10 of FIG. 8 are also stacked in the same inward counter-clockwise direction. The elements 10 may be stacked in alternating directions to create a different overlap as well. FIG. 9 shows an array 100 comprised of three stacked elements 10. An array 100 may be comprised of any number of elements 10 in any combination of rotational directions or offsets desired. The elements 10 may be comprised of different materials and may be of different configurations and may be charged with varying power individually or in groups depending on the desired application. Alternatively, all of the elements 10 of an array 100 may be comprised of the same material and of the same configuration and charged at the same power. In this respect, the anticipated device is very versatile. Other anticipated embodiments may have flat elements of different configurations (not twin reverse spiral) that are positioned perpendicularly to a fluid flow with similar advantages of more efficient heat generation.

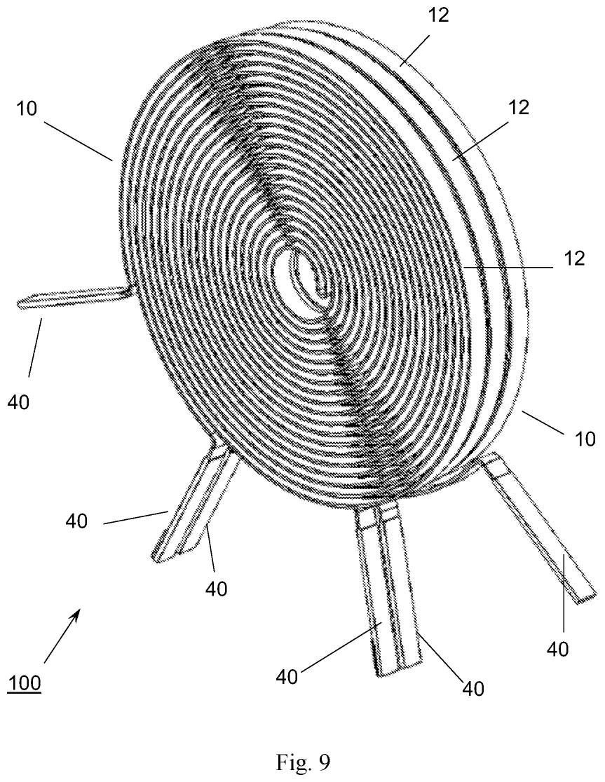

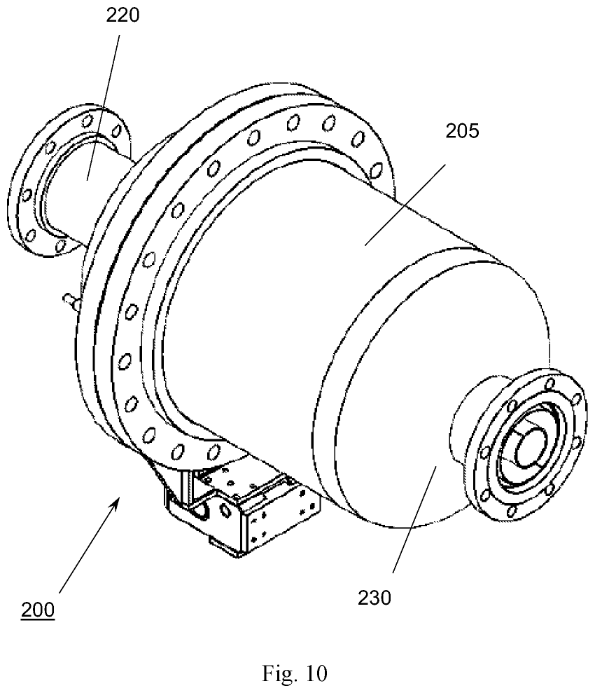

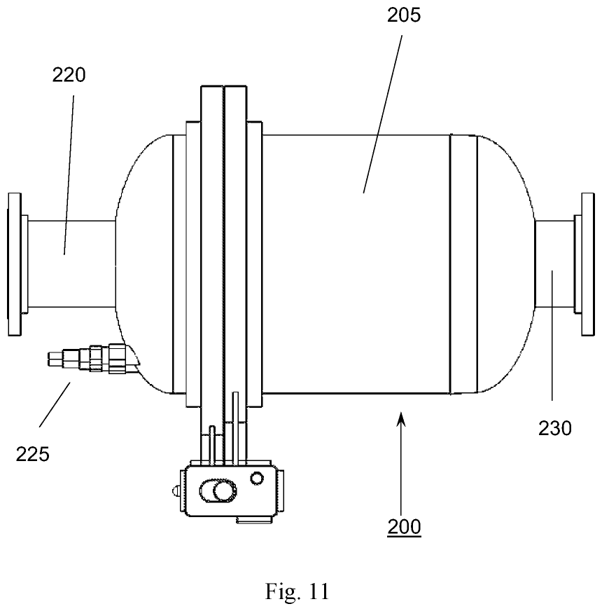

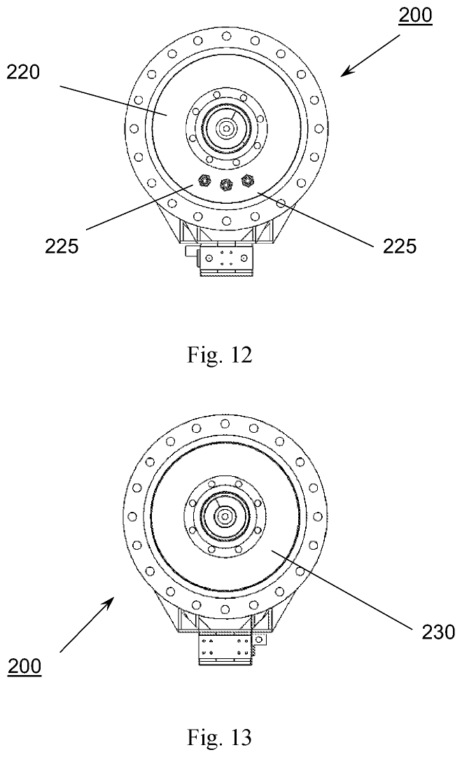

FIG. 10 shows a hot gas generator 200 which may employ the single or multiple twin reverse spiral heating elements 10 described above. The elements 10 are placed with in a housing 205 having a gas or air intake end 220 and a heated exhaust end 230. The spiral elements 10 are positioned within the housing 205 in a manner to be perpendicular to the direction of the gas flow through the generator 200. The spiral face of the element(s) 10 will face the flow so that the flow will pass through and around the spirals 15 and 20. The heating elements 10 may be connected to and supported by bus bars 115 connected to the terminals 40 of the heating elements 10. The bus bars 115 will be connected to the power source and controller of the generator 200 thereby electrically powering the elements 10 of the generator 200.

The generator housing may be lined with porous refractory that encases the elements. The center of the spiral elements may be lined with refractory as well. The porosity of the refractory may be augmented with grooves or passageways providing a further means of gas flow. In operation, a gas will be forced through the housing and its refractory and heating elements. The gas will pick up heat from the charged and heated elements as well as the heated refractory, the combination of which will super-heat the gas and can produce plasma or activated species.

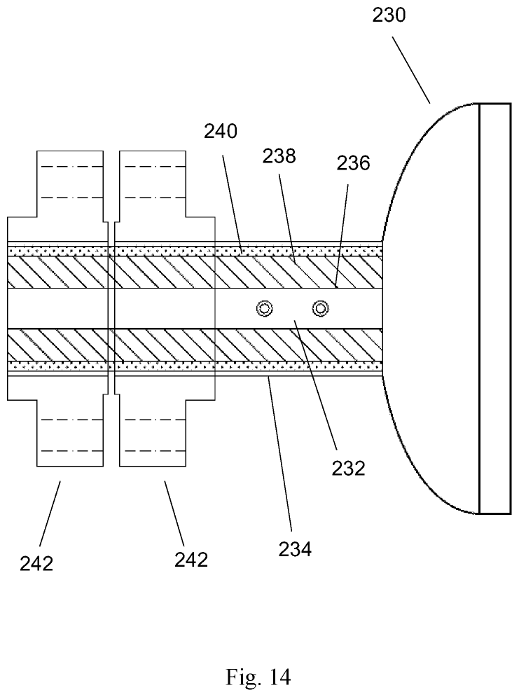

FIG. 14 shows an anticipated embodiment of the exhaust end 230 of the generator 200. The exhaust end 230 has an exhaust line 232 that is tubular in configuration projecting out of the exhaust end 230 comprised of an outer liner 234. Within the outer liner 234 there is an inner liner 236. The inner liner 236 is surrounded by refractory 238. Between the refractory 238 and the outer liner 234 is an air gap 240. The air gap 240 and the refractory 238 may completely surround the inner liner 236 which may be comprised of a material such as Inconel 625. The hot gas produced by the generator 200 is projected out of the exhaust end 230 through the inner liner 236 which is insulated by the refractory 238, the air gap 240 and the outer liner 234. The flanges 242 act to attach the exhaust line 232 to a point of application. The refractory 238 is used to fixture the inner liner 236 and provide insulation and allow for the thin air gap 240. The combination of inner liner 236, outer liner 234, refractory 238 and air gap 240 is a three material composite insulation comprising of a metal, ceramic and a gas allowing for a cooler flange 242 yet remaining within allowed pressure vessel codes.

The disclosed element configurations have been found to have extremely high power density and contact area per power applied. Also, the configurations exhibit very high resistance to distortion because of the flexibility of the SH design that can accommodate movement without putting pressure on joints and or enclosures. Many possibilities of use for scaling the elements are anticipated as well. For example, a single 10″ element can be easily able to deliver up to 1000 KW of power. And the element design alloys for constant busbar contact instead of busbar contacts only at the end in a flow device.

The elements may be constructed of any ceramic such as molysilicide, silicon carbide, lanthanum bromide or conducting oxides such as ferrites or metallics including Ni—Cr or Fe—Al—Cr, silicon, chromium, boron phosphorous, nitrogen, phosphorus containing materials or combinations thereof. Element materials are expected to contain grain stabilizers such as Ti B2 for high creep resistant properties and good creep-fatigue resistance.

Another advantage lies in spreading out the flow to reduce the surface load. Such a surface load reduction will greatly add to life of a device i.e., make the unit a sustainability enhancing product. More fluid comes in contact with the flat face of the disclosed embodiment as opposed to an elongated or u-shaped element allowing for greater efficiency in heating. Less fluid passes through the unit without being sufficiently heated

The design allows for catalysts and other chemical reaction elements to do the following: gases such as methane CH₄(g) can be removed through steam reforming; CH₄(g)+H₂O(g)=CO(g)+3H₂(g) steam reforming above ˜750° C. (both CO and H₂ are reducing gasses for several oxides); the reaction 2CO(g)+NaN₃=2C+NaO₂+1.5N₂(g) is possible even at medium temperatures; the Boudouard reaction 2CO(g)=CO₂(g)+C can occur below ˜750° C. (similarly, Fe₂O₃+hot CO(g) can yield clean Fe); hot CO₂ or CO can easily be reacted with azides of Na, Ca, Li etc. to make useful solids or liquids, while the oxides of alkali metals can be recovered; NaN₂+CO₂ or Ca—N or Li—N compounds can be reacted with hot CO₂; oxides can be reacted with hot CO for clean metal production; syngas can be easily heated (various combinatorial ratios are feasible); hot CO₂(g)+NaN₃=C+NaO₂+1.5N₂(g) is negative free energy with good kinetics above 980° C. (catalysts are available).

In between the SH (Spring Heater) coils contemplated non active sandwich elements that can act as heat reservoirs or enhancers of residence time if required. Various combinations of reactive substrates for catalysis or for making steam from a liquid are also easily contemplated.

Flat element configurations may be positioned perpendicular or near perpendicular to the gas flow allowing it to pass through and across the element. Elements may be stacked as described for the spiral elements. The stack may be comprised of like or dissimilar element configurations and materials which may be individually at varying power levels depending on the application. There may be refractory placed between the stacked element as well.

In general, flat element configurations refer to an arrangement of elements where the gas or heat flow travels in a perpendicular direction relative to the heating coil rather than parallel to an elongated u-shaped or straight coil. Examples of flat heating elements are presented in FIGS. 15-19. FIG. 15 is a view of a flat round element 250 configured in a circular pattern. This pattern or face, as in any flat element contemplated herein, would be positioned perpendicular to a fluid flow as opposed to a linear or elongated U-type elements that are positioned parallel to a flow. The entire face or pattern of 250 or any flat element would be in contact with the flow leading to more efficient heating.

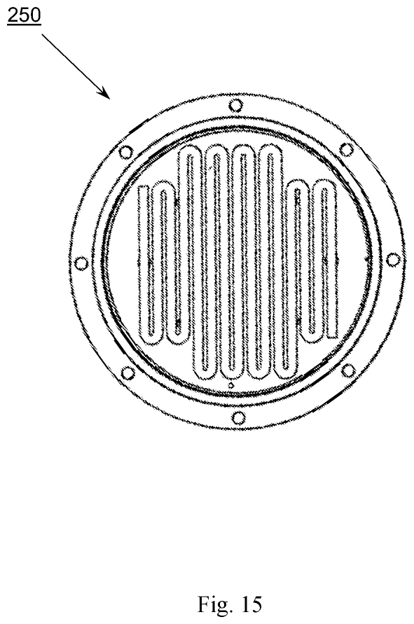

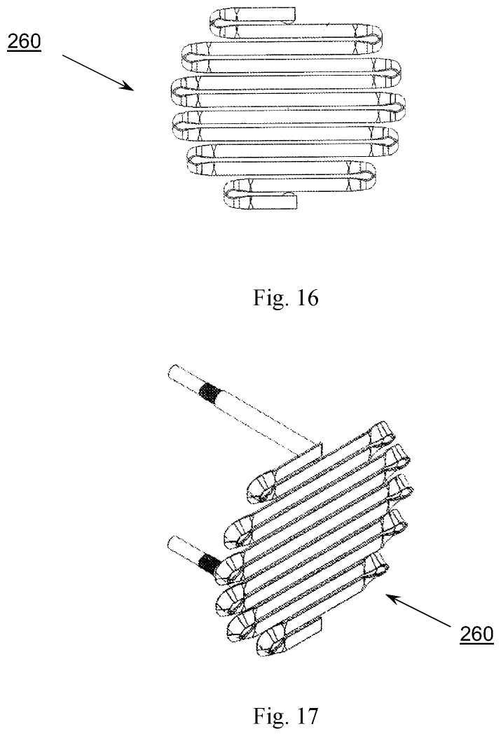

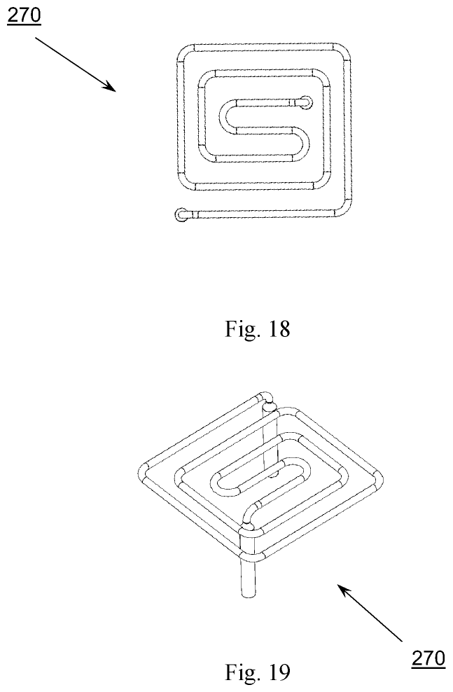

FIGS. 16 and 17 show a twisted element 260 comprised of bends and twists of flat rectangular heating material stock forming a generally flat surface. A fluid flow could pass into and through the face. FIGS. 18 and 19 present a flat square element 270 comprised of bends forming a square surface or face. Element 270 is fabricated from round stock that is bent to the desired configuration. Flat stock and other geometries are contemplated as well.

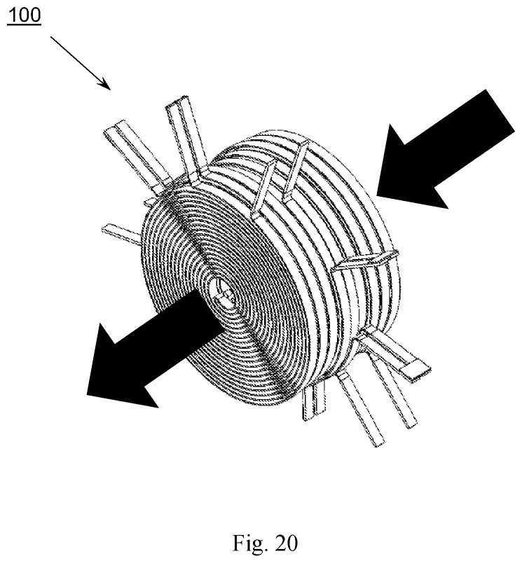

FIG. 20 shows the anticipated direction of a fluid flow in relationship to an array of elements 100. The black arrows indicate the direction of the flow into and out of the array 100 perpendicular to the face of the element 10. All configurations of flat elements would have similar positioning to the direction of a fluid flow.

As contemplated in this application the flat elements may be stacked so that the gas flow travels perpendicularly through the stack of elements gathering extra heat during the process. There are no flat coil high power stacked configurations anywhere in the literature. The literature has focused on coils that are long or elongated. Presented here are flatter element configurations with major benefits stemming from the flatness and high power density orthogonal to the direction of flow.

Such elements can easily be located inside or outside pressure vessel or pressurized singular or multiple tubes. The elements make possible an ortho generator design which comprises a door or hatch allowing access to the interior of the unit without disturbing the flow path or the tubing in and out of the shell. In such a design the maintenance on a heating unit, by itself, or as part of a system would be greatly simplified. The tubing or tube is generally used for holding the array or multiple heaters in place while preventing heat loss to the shell. This cuts down on the need to water cool the shell. Concentric tubes and funnels can be used. Some uses and applications are sensitive to refractory dust. Such a design could minimize or eliminate the dust by eliminating refractory contact. For very high power MW systems the shell could also have multiple tubes surrounded by one or many heat shield tubes.

The SH unit, as depicted above, allows for energy savings and footprint savings by allowing the incorporation of effective radiation shields, internal air cooling and similar features. In addition, because of the compact designs low flow water can be used to cool the shells thus avoiding the use of expensive alloys.

Commonly, gas heaters require at least a 1 psi pressure drop. With the coil designs in the present application, pressure drops of less than 0.1 psi for a 30 KW system are anticipated. Such is extremely important for energy efficiency. Gas electric process air/gas heaters equipped with such flat coils are highly efficient and scalable. Low pressure drops lead to energy savings. In a 2000 SCFM flow, a 5 psi lower pressure drop is equivalent to about 30 KW in power savings. Such may be a savings of nearly $25,000 per year. The applicants have experimentally measured a 0.0043 psi pressure drop for an air heater at 700° C. The low anticipated pressure drops allow flows to be initiated with a fan or blower rather than compressed air or gas allowing for more energy savings.

Although preferred embodiments of the element and generation structures are presented in the above specification, the scope of the invention is not to be limited by them. Other flat element configurations and heat generation applications for a variety of fluids are anticipated by the applicants.

What is claimed is:

1. An electrically charged heating element comprised of an element material configured in a twin reversed spiral orientation where the element material is comprised of stock that is non-round in cross section is wound inwardly in an initial spiral in a single plane to a point near a mid-point of the electrically charged heating element where the element material reverses course and is then wound in a secondary spiral outwardly in an opposite direction and in the single plane as the initial spiral until the material reaches the outside of the initial spiral.

2. The heating element of claim 1 further comprised of a terminal at each end of the element material.

3. The heating element of claim 2 wherein the terminal at each end of the element material projects in a perpendicular direction from the outer surface of the element.

4. (canceled)

5. The heating element of claim 1 wherein the initial spiral is wound in a clockwise direction.

6. The heating element of claim 1 wherein the initial spiral is wound in a counter-clockwise direction.

7. The heating element of claim 1 further comprising at least one ceramic spacer placed between the spirals.

8. An array of multiple electrically charged heating elements, each of the multiple heating elements being comprised of an element material configured in a twin reversed spiral orientation where the element material is comprised of stock that is non-round in cross section wherein the element material is wound inwardly in an initial spiral in a single plane to a point near a mid-point of the electrically charged heating element where the element material reverses course and is then wound in a secondary spiral outwardly in an opposite direction and in the single plane as the initial spiral until the material reaches the outside of the initial spiral wherein the elements each comprise a flat configuration comprised of element material comprising elongated stock bent in a pattern predominately in a single plane to form a flat oriented surface comprised of the pattern bent in the elongated stock wherein the elements are arranged in a stacked side-by-side configuration parallel to each other and positioned so that the flat oriented surface is perpendicular to a fluid flow.

9. The array of multiple of electrically charged heating elements of claim 8 wherein the pattern comprises a twin reversed spiral orientation where the element material is wound inwardly in an initial spiral to a point near a mid-point of the electrically charged heating element where the material reverses course and is then wound in a secondary spiral outwardly in an opposite direction and in the single plane of the initial spirals until the material reaches the outside of the initial spiral.

10. The array of multiple electrically charged heating elements of claim 9 wherein at least one of the elements is positioned to spiral inwardly in a clockwise direction and at least one of the elements is positioned to spiral inwardly in a counter-clockwise direction.

11. The array of multiple electrically charged heating elements of claim 9 wherein the elements spiral inwardly in the same direction.

12. The array of multiple electrically charged heating elements of claim 9 wherein the elements are offset by rotating at least one of the elements at an angle different than at least one other of the elements.

13. The array of multiple electrically charged heating elements of claim 12 wherein at least one of the elements is rotationally offset between 30° to 60°.

14. A gas heater comprised of at least one electrically charged heating element, each electrically charged heating element being comprised of an element material configured in a twin reversed spiral orientation where the element material is comprised of stock that is non-round in cross section wherein the element material is wound inwardly in an initial spiral in a single plane to a point near a mid-point of the electrically charged heating element where the element material reverses course and is then wound in a secondary spiral outwardly in an opposite direction and in the single plane as the initial spiral until the material reaches the outside of the initial spiral wherein the element comprises element material in a flat configuration comprised of elongated stock bent in a pattern predominately in a single plane to form a flat oriented surface comprised of the pattern bent in the elongated stock wherein the element is positioned so that the flat oriented surface is perpendicular to a fluid flow.

15. The gas heater of claim 14 further comprising a casing having a intake end and an exhaust end and refractory material positioned inside of the casing and surrounding the at least one electrically charged heating element.

16. The gas heater of claim 15 further comprising a means of access positioned on and through the casing allowing access to the at least one electrically charged heating elements within the casing.

17. The gas heater comprised of at least one electrically charged heating element of claim 14 wherein the flat oriented surface is configured in a twin reversed spiral orientation where the element material is wound inwardly in an initial spiral to a point near a mid-point of the electrically charged heating element where the material reverses course and is then wound in a secondary spiral outwardly in an opposite direction and in the single plane of the initial spiral until the material reaches the outside of the initial spiral.

18. The gas heater comprised of at least one electrically charged heating element of claim 14 further comprising an array of multiple electrically charged heating elements wherein the elements each comprise element material in a flat configuration comprised of elongated stock bent in a pattern predominately in the same plane to form a flat oriented surface comprised of the pattern bent in the elongated stock wherein the elements are arranged in a stacked side-by-side configuration parallel to each other and positioned so that the flat oriented surface is perpendicular to a fluid flow.

19. The gas heater comprised of at least one electrically charged heating element of claim 16 wherein the surface pattern of the elements of the array comprises a twin reversed spiral orientation where the element material is wound inwardly in an initial spiral to a point near a mid-point of the electrically charged heating element where the material reverses course and is then wound in a secondary spiral outwardly in an opposite direction and in the same plane as the initial spiral until the material reaches the outside of the initial spiral.

20. The gas heater comprised of at least one electrically charged heating element of claim further comprising an exhaust line projecting out of the exhaust end of the gas heater wherein the exhaust line comprises and outer liner, an inner liner within the outer liner, refractory surrounding and in contact with the inner liner whereby the refractory delineates an air gap between the refractory and the outer liner whereby the inner liner, the outer liner, the refractory and the air gap provide thermal insulation for the exhaust line.
